(19) United States
(12) Patent Application Publication
(10) Pub. No.: US 2020/0118402 A1
(43) Pub. Date: Apr. 16, 2020

(54) DIGITAL HALL PASS

(71) Applicant: Jose Luis Grafals, Bronx, NY (US)

(72) Inventor: Jose Luis Grafals, Bronx, NY (US)

(21) Appl. No.: 16/598,424

(22) Filed: Oct. 10, 2019

Related U.S. Application Data
(60) Provisional application No. 62/743,636, filed on Oct. 10, 2018.

(51) Int. Cl. G08B 7/06; H02J 7/02; H02J 50/10; G08B 21/18

(52) U.S. Cl. CPC G08B 7/06; G08B 21/182; H02J 50/10; H02J 7/025

(57) ABSTRACT

A digital hall pass dimensioned and adapted to operatively associate with only one docking station is provided. The docking station provides programmable input devices for selectively setting a predetermined time and audible and visual output associated with the digital hall pass. The digital hall pass travels with a student, and if the digital hall pass is not placed back in its respective docking station prior to the associated predetermined time expires, the digital hall pass will emit the programmed audible and visual output through both the digital hall pass and the docking station so that the student and class monitor/teach will be informed of the tardiness.

### CROSS-REFERENCE TO RELATED APPLICATION

This application claims the benefit of priority of U.S. provisional application No. 62/743,636, filed 10 Oct. 2018, the contents of which are herein incorporated by reference.

### BACKGROUND OF THE INVENTION

The present invention relates to alert systems and, more particularly, a portable and digital hall pass adapted to track the time school students occupy associated hallways and alert students and hall monitors when the allowable time to traverse the associated hallways lapses.

Students tend to roam school hallways before, during, and after classes for a variety of reasons. Though there are justifiable reasons for students being in hallways, extending roaming of the hallways is also symptomatic of tardiness, truancy or absenteeism. Such roaming also poses safety issues, first when it causes congestion, and second when the school comes under attack by a bad actor and one or more students are unaccounted for. Traditionally, monitoring the hallways includes an individual who checks for paper hall passes. A paper pass does not have, however, the technology capabilities to monitor allotted breaks. And the cost and/or wasted resources of having a teacher or administrator carry out the function of following up on allotted breaks can be prohibitive during these times of shrinking school budgets.

As can be seen, there is a need for a portable digital hall pass to track the allotted time for students occupying associated hallways and provide alerts when that allotted time has passed. The present invention is adapted to monitor the time and warn individuals (students as well as staff members) when the predetermined granted time in an occupied space has lapsed, thereby reducing the congestion of students from roaming the school hallways by limiting the amount of time that they are allowed to use the restroom or office visit, as well as providing a method of accounting for students if there is a tragedy in the school.

### SUMMARY OF THE INVENTION

In one aspect of the present invention, a digital hall pass system includes the following: a digital hall pass body encompassing a first visual and audible output device and an electrically coupled computer; a charging conductor disposed along a periphery of the digital hall pass body; a docking station having a void dimensioned to receive a portion of the digital hall pass body; a second visual and audible output device coupled to the docking station; one or more programmable inputs for setting a predetermined time and a predetermined visual and/or audible output; and a charging inductor disposed along a periphery of the void so that when the digital hall pass body is received in the void, the charging conductor and the charging inductor operatively associate for powering the digital hall pass; a wireless pad extending beyond a boundary of the void so as to support the digital hall pass body operatively associated therein; the computer configured so that if the charging conductor and the charging inductor are not operatively associated within the predetermined time, then the first and second visual and audible output devices emit the predetermined visual and/or audible output, wherein the charging conductor will only operatively associate with said charging inductor, and wherein the charging inductor is dimensioned to receive only said charging conductor.

In another aspect of the present invention, the digital hall pass system includes the following: a digital hall pass body encompassing a first visual and audible output device and an electrically coupled computer; a power source housed in the digital hall pass body; a charging inductor disposed along a periphery of the digital hall pass body and electrically coupled to the power source; a docking station having a void dimensioned to receive a portion of the digital hall pass body; a second visual and audible output device coupled to the docking station; one or more programmable inputs for setting a predetermined time and a predetermined visual and/or audible output; and a charging conductor disposed along a periphery of the void so that when the digital hall pass body is received in the void, the charging inductor and the charging conductor operatively associate for powering the docking station; a wireless pad extending beyond a boundary of the void so as to support the digital hall pass body operatively associated therein; the computer configured so that if the charging conductor and the charging inductor are not operatively associated within the predetermined time, then the first and second visual and audible output devices emit the predetermined visual and/or audible output, wherein the charging conductor will only operatively associate with said charging inductor, wherein the charging inductor is dimensioned to receive only said charging conductor.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a perspective view of an exemplary embodiment of the present invention;

FIG. 3 is a section view of an exemplary embodiment of the present invention, taken along line 3-3 in FIG. 1;

FIG. 4 is a perspective view of an exemplary embodiment of the present invention; and

FIG. 5 is a flow chart view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a digital hall pass dimensioned and adapted to operatively associate with only one docking station. The docking station provides programmable input devices for selectively setting a predetermined time and audible and visual output associated with the digital hall pass. The digital hall pass travels with the student, and if the digital hall pass is not placed back in its respective docking station prior to the associated predetermined time expires, the digital hall pass will emit the programmed audible and visual output through both the digital hall pass and the docking station so that the class monitor or teach will be informed of the tardiness of the student with the digital hall pass.

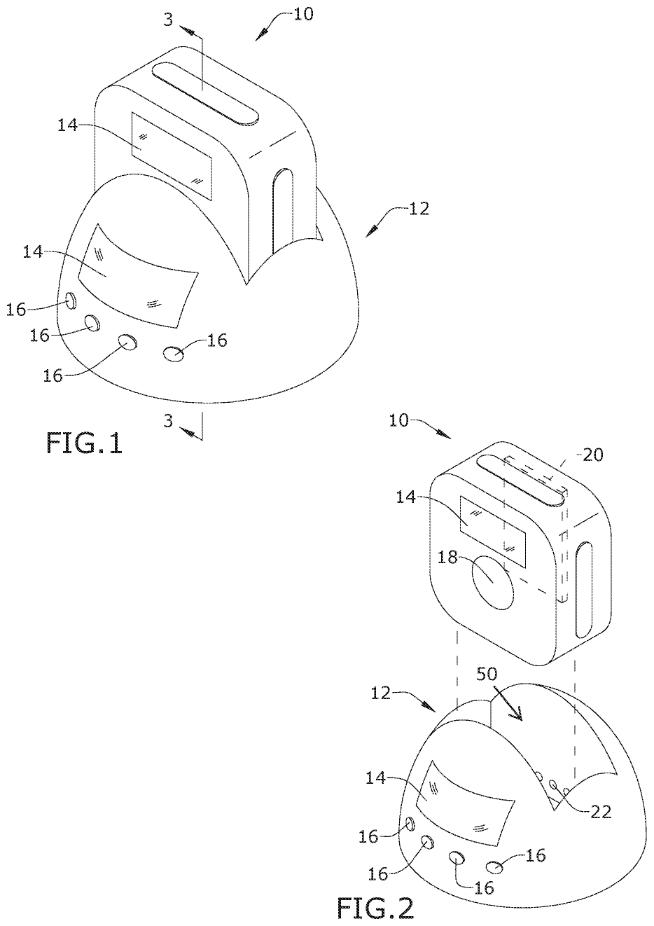

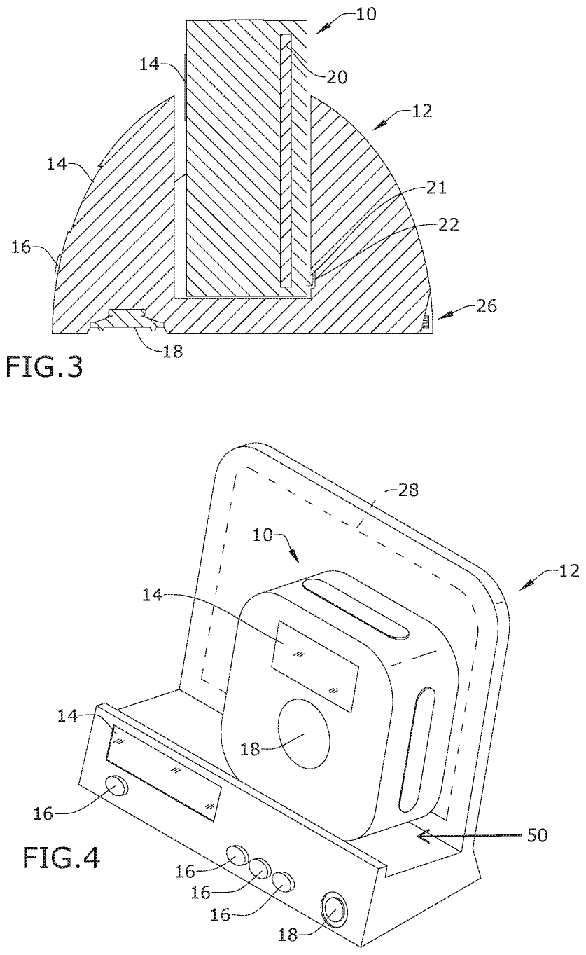

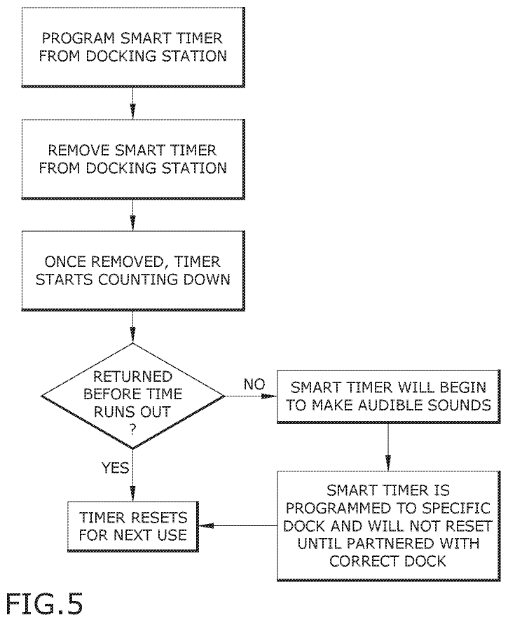

Referring now to FIGS. 1 through 5, the present invention may include a digital hall pass 10 dimensioned and adapted to electronically associate with a docking station 12. The digital hall pass 10 and the docking station 12 may include a computer with a user interface 14. The computer may include at least one processing unit coupled to a form of memory. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The docking station 12 may provide programmable input buttons 16, audio output devices 18, and a power source 20, such as a lithium battery. The docking station 12 may provide a void 50 dimensioned to receive and electronically associate with the digital hall pass 10. In certain embodiments, the void 50 may be coupled with a wireless pad 28 so as to support the digital hall pass 10 therein. A portion of the interface of the void 50 and the docking station 12 may include a second charging inductor/conductor 22 electrically connected to the power source 20. The digital hall pass 10 may provide a first charging conductor/inductor 21 to operatively associate with the second charging inductor/conductor 22 so that the digital hall pass 10 can be charging while associated with the docking station 12. The docking station 12 may provide a DC dock charging adapter 26.

The digital hall pass 10 is adapted to be a portable timer to monitor the time as set by an administrator. As the timer winds down, the user interface(s) 12 may light up or otherwise providing alarming output in order notify the person in possession of the present invention (as well as nearby the docking station 12). This output may be audible (e.g., chiming), visual LED light effects, or the like.

The digital hall pass 10 may be configured to count down to zero and alert staff members, utilizing Bluetooth, Wi-Fi and GPS capabilities. This digital hall pass 10 will be designed of sturdy components for years of abuse. It will sync only to its designated docking station 12. The docking station 12 may be the main component and is adapted to communicate information with the digital hall pass 10 and enable features to be changed wirelessly. A user can configure the Wi-Fi, Bluetooth, and GPS, and set the time, date, loudness and password of the portable timer via the programmable buttons 16.

A method of using the present invention may include the following. The digital hall pass 10 disclosed above may be provided. Once the digital hall pass 10 is powered and configured, the digital hall pass 10 starts the preconfigured countdown upon being removed from the docking station 12. It will not stop counting until the digital hall pass 10 is placed back on the docking station 12. If the portable timer is not placed back before the time expires, the digital hall pass 10 will start flashing red and chiming or otherwise provide alarming output. The present invention is to replace the hall pass used in the schools with a digital hall pass 10 that will monitor time and reduce the unnecessary congestion of students hanging out in the hall ways through the alarming output, alerting staff members that time has expired and should be in class. Now an administration can take proper action without guessing if the student is lying about their time spent in the hallways.

In certain embodiments, these components can be reconfigured to function as a countdown door chime. For example, if the door is left open too long, the unit will flash and chime after a preset time.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A digital hall pass system, comprising:
a digital hall pass body encompassing a first visual and audible output device and an electrically coupled computer;
a charging conductor disposed along a periphery of the digital hall pass body;
a docking station having a void dimensioned to receive a portion of the digital hall pass body;
a second visual and audible output device coupled to the docking station;
one or more programmable inputs for setting a predetermined time and a predetermined visual and/or audible output; and
a charging inductor disposed along a periphery of the void so that when the digital hall pass body is received in the void, the charging conductor and the charging inductor operatively associate for powering the digital hall pass.

2. The digital hall pass system of claim 1, further comprising:
a wireless pad extending beyond a boundary of the void so as to support the digital hall pass body operatively associated therein.

3. The digital hall pass system of claim 1, further comprising:
the computer configured so that if the charging conductor and the charging inductor are not operatively associated within the predetermined time, then the first and second visual and audible output devices emit the predetermined visual and/or audible output.

4. The digital hall pass system of claim 1, wherein the charging conductor will only operatively associate with said charging inductor.

5. The digital hall pass system of claim 4, wherein the charging inductor is dimensioned to receive only said charging conductor.

6. A digital hall pass system, comprising:
a digital hall pass body encompassing a first visual and audible output device and an electrically coupled computer;
a power source housed in the digital hall pass body;
a charging inductor disposed along a periphery of the digital hall pass body and electrically coupled to the power source;
a docking station having a void dimensioned to receive a portion of the digital hall pass body;
a second visual and audible output device coupled to the docking station;
one or more programmable inputs for setting a predetermined time and a predetermined visual and/or audible output; and
a charging conductor disposed along a periphery of the void so that when the digital hall pass body is received in the void, the charging inductor and the charging conductor operatively associate for powering the docking station.

7. The digital hall pass system of claim 6, further comprising:
a wireless pad extending beyond a boundary of the void so as to support the digital hall pass body operatively associated therein.

8. The digital hall pass system of claim 6, further comprising:
the computer configured so that if the charging conductor and the charging inductor are not operatively associated within the predetermined time, then the first and second visual and audible output devices emit the predetermined visual and/or audible output.

9. The digital hall pass system of claim 8, wherein the charging conductor will only operatively associate with said charging inductor.

10. The digital hall pass system of claim 9, wherein the charging inductor is dimensioned to receive only said charging conductor.
